(19) United States
(12) Patent Application Publication
(10) Pub. No.: US 2015/0270516 A1
(43) Pub. Date: Sep. 24, 2015

(54) ENHANCED FABRICATION EV BATTERY PACK

(71) Applicant: Ford Global Technologies, LLC, Dearborn, MI (US)

(72) Inventors: Edward Paul Mcleskey, Pinckney, MI (US); Steve Droste, Dearborn, MI (US)

(73) Assignee: FORD GLOBAL TECHNOLOGIES, LLC, Dearborn, MI (US)

(21) Appl. No.: 14/223,667

(22) Filed: Mar. 24, 2014

(51) Int. Cl. H01M 2/10

(52) U.S. Cl. CPC H01M 2/1077

(57) ABSTRACT

A battery pack for an electrified vehicle. An illustrative embodiment of the battery pack includes a battery pack frame and a plurality of tubular venting components in the battery pack frame. At least one of the battery pack frame and the plurality of tubular venting components is fabricated at least in part of a tubular material. An enhanced electrified vehicle battery pack fabrication method is also disclosed.

### FIELD

Illustrative embodiments of the disclosure generally relate to Electrified Vehicles (EVs) such as Hybrid Electric Vehicles (HEVs). More particularly, illustrative embodiments of the disclosure relate to an enhanced fabrication EV battery pack having components which are fabricated of a tubular material for enhanced performance and reduced cost of the battery pack.

### BACKGROUND

In the design and fabrication of EV battery pack s such as high voltage traction batteries, weight, cost, space and safety considerations are important. Numerous constraints negatively affect customer acceptance of an electrified vehicle. Reducing the weight, size and strength of the battery pack for crash protection to reduce cost may be important objectives to improve these constraints.

Accordingly, an enhanced fabrication EV battery pack having components which are fabricated of a tubular material for enhanced performance and reduced cost of the battery pack may be desirable.

### SUMMARY

Illustrative embodiments of the disclosure are generally directed to a battery pack for an electrified vehicle. An illustrative embodiment of the battery pack includes a battery pack frame and a plurality of tubular venting components in the battery pack frame. At least one of the battery pack frame and the plurality of tubular venting components is fabricated at least in part of a tubular material.

Illustrative embodiments of the disclosure are further generally directed to an enhanced electrified vehicle battery pack fabrication method. An illustrative embodiment of the method includes fabricating an electrified vehicle battery pack including a battery pack frame and tubular venting and cooling components. At least one of the battery pack frame and the tubular venting and cooling components is fabricated at least in part of a tubular material.

### BRIEF DESCRIPTION OF THE DRAWINGS

Illustrative embodiments of the disclosure will now be described, by way of example, with reference to the accompanying drawings, in which:

FIG. 1 is a partially schematic top view of an illustrative embodiment of an enhanced fabrication EV battery pack;

FIG. 2 is a flow diagram of an illustrative embodiment of an enhanced EV battery pack fabrication method;

FIG. 3 is a front perspective view of an alternative illustrative embodiment of an enhanced fabrication EV battery pack; and

FIG. 4 is a rear exploded perspective view of the illustrative enhanced fabrication EV battery pack illustrated in FIG. 3.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable users skilled in the art to practice the disclosure and are not intended to limit the scope of the claims. Moreover, the illustrative embodiments described herein are not exhaustive and embodiments or implementations other than those which are described herein and which fall within the scope of the appended claims are possible. Furthermore, there is no intention to be bound by any expressed or implied theory presented in the preceding technical field, background, brief summary or the following detailed description.

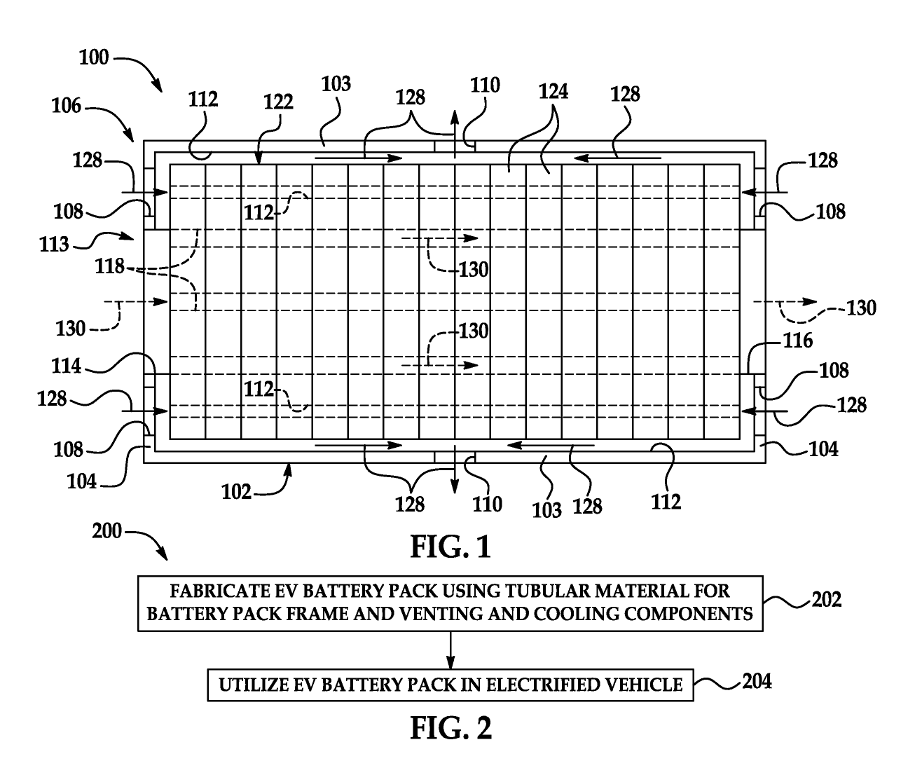

Referring initially to FIG. 1, an illustrative embodiment of an enhanced fabrication EV battery pack is generally indicated by reference numeral 100. The EV battery pack 100 may include a battery pack frame 102. The battery pack frame 102 may include, in whole or in part, a tubular material such as tubular aluminum, steel and/or other metal, for example and without limitation. In some embodiments, the battery pack frame 102 may include a battery pack frame bottom (not shown) and a pair of frame side walls 103 and a pair of frame end walls 104 extending from the battery pack frame bottom.

A battery cell array 122 is supported by the battery pack frame 102. The battery cell array 122 may include multiple battery cells 124. The EV battery pack 100 may include tubular venting components 106. The tubular venting components 106 may include at least one thermal medium inlet vent 108 and at least one thermal medium outlet vent 110 provided in the battery pack frame 102. At least one thermal medium passage 112 may extend between and communicate with the thermal medium inlet vent or vents 108 and the thermal medium outlet vent or vents 110. In some embodiments, at least one thermal medium passage 112 may extend or wind around the exterior or perimeter of the battery cell array 122 or may extend or wind through the battery cell array 122 in a selected pattern. The tubular venting components 106 may further include connecting components (not shown) which couple or connect the thermal medium inlet vent or vents 108 and the thermal medium outlet vent or vents 110 to the thermal medium passage or passages 112. Accordingly, each thermal medium passage 112 is adapted to convey a stream of flowing thermal medium 128 from the thermal medium inlet vent or vents 108 to the thermal medium outlet vent or vents 110 in cooling of the battery cell array 122. In some embodiments, each thermal medium inlet vent 108, each thermal medium outlet vent 110 and/or each thermal medium passage 112 may include, in whole or in part, a tubular material such as tubular steel, aluminum and/or other metal, for example and without limitation.

The EV battery pack 100 may include cooling components 113. The cooling components 113 may include at least one coolant inlet 114 and at least one coolant outlet 116 provided in the battery pack frame 102. At least one coolant passage 118 may extend between and communicate with the coolant inlet or inlets 114 and the coolant outlet or outlets 116. In some embodiments, at least one coolant passage 118 may extend or wind through or around the perimeter of the battery cell array 122. The cooling components 113 may further include connecting components (not shown) which couple or connect the coolant inlet or inlets 114 and the coolant outlet or outlets 116 to the coolant passage or passages 118. Accordingly, each coolant passage 118 is adapted to convey a stream of flowing liquid coolant 130 from the coolant inlet 114 to the coolant outlet 116 in cooling of the battery cell array 122. In some embodiments, each coolant inlet 114, each coolant outlet 116 and/or each coolant passage 118 may include, in whole or in part, a tubular material such as tubular steel, aluminum and/or other metal, for example and without limitation.

In exemplary application, the battery cells 124 of the battery cell array 122 generate electrical power for an electrified vehicle (not shown) typically in the conventional manner. At least one stream of flowing thermal medium 128 flows through the thermal medium inlet vent or vents 108, the thermal medium passage or passages 112 and the thermal medium outlet vent or vents 110, respectively, to cool the battery cell array 122. At least one stream of flowing coolant 130 flows through the coolant inlet or inlets 114, the coolant passage or passages 118 and the coolant outlet or outlets 116, respectively, to cool the battery cell array 122.

It will be appreciated by those skilled in the art that the tubular material construction of the battery pack frame 102, the thermal medium inlet vents 108, the thermal medium outlet vents 110, the thermal medium passages 112, the coolant inlet 114, the coolant outlet 116, the coolant passages 118 and/or other components significantly enhance weight, cost, space, safety and other parameters of the EV battery pack 100. These expedients may facilitate a reduction in the weight as well as enhanced crash protection and lower cost of the battery cell array 122. Moreover, utilization of tubular material components instead of plastic components may eliminate the volume and reduce the cost which is demanded by utilization of plastic duct work for the tubular venting and cooling components. The EV battery pack 100 and its components can be fabricated using casting, molding, machining and/or other manufacturing techniques which are known by those skilled in the art.

Referring next to FIG. 2, a flow diagram 200 of an illustrative embodiment of an enhanced EV battery pack fabrication method is shown. At block 202, an EV battery pack is fabricated. The EV battery pack may be fabricated in whole or in part using a tubular material such as tubular steel and/or tubular aluminum, for example and without limitation, for the battery pack frame and the tubular venting components and/or cooling components. The tubular venting components of the EV battery pack may include at least one thermal medium inlet vent, at least one thermal medium outlet vent and at least one thermal medium passage extending between the thermal medium inlet vent or vents and the thermal medium outlet vent or vents. The cooling components of the EV battery pack may include at least one coolant inlet, at least one coolant outlet and at least one coolant passage extending between the coolant inlet or inlets and the coolant outlet or outlets. At block 204, the EV battery pack may be utilized in an electrified vehicle. In some embodiments, the electrified vehicle may be a Hybrid Electric Vehicle (HEV).

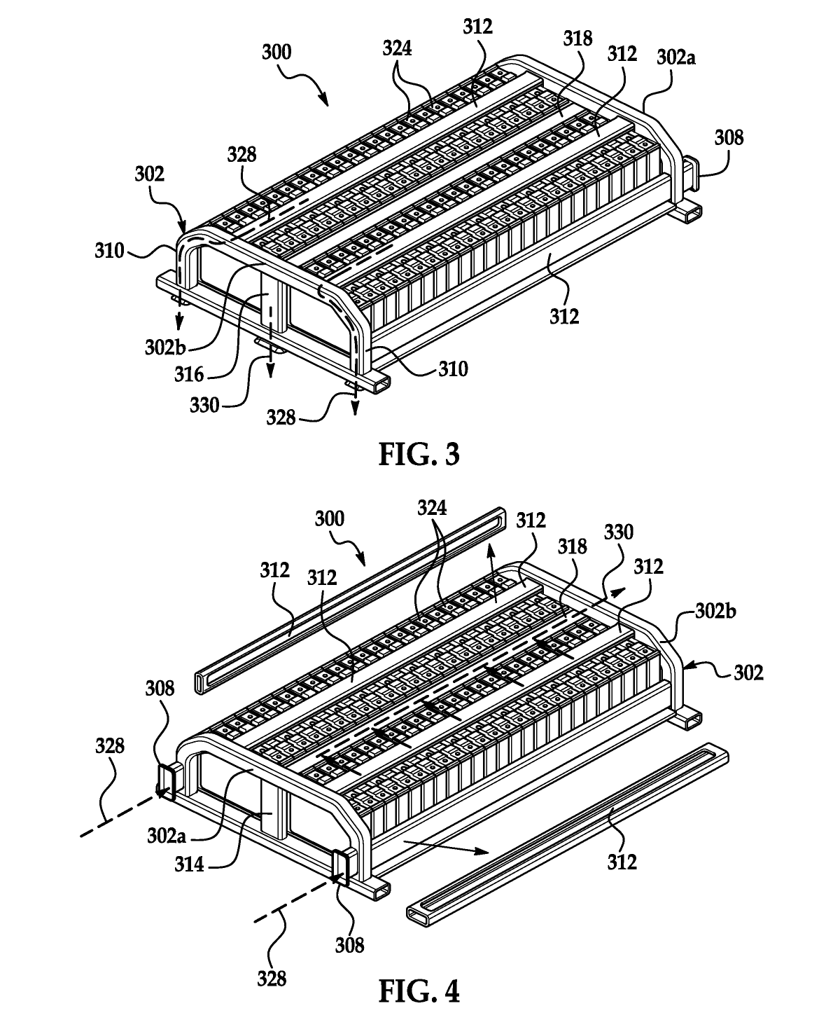

Referring next to FIGS. 3 and 4, an alternative illustrative embodiment of an enhanced fabrication EV battery pack 300 is shown. The EV battery pack 300 may include a tubular battery pack frame 302 having a tubular inlet manifold 302a and a tubular outlet manifold 302b. As shown in FIG. 4, the inlet manifold 302a may include multiple spaced-apart, tubular thermal medium inlet vents 308. As shown in FIG. 3, the outlet manifold 302b may include multiple spaced-apart tubular thermal medium outlet vents 310. Multiple thermal medium passages 312 may establish fluid communication between the thermal medium inlet vents 308 and the thermal medium outlet vents 310.

As further shown in FIG. 4, the inlet manifold 302a may further include at least one tubular coolant inlet 314. As shown in FIG. 3, the outlet manifold 302b may include at least one tubular coolant outlet 316. At least one coolant passage 318 may establish fluid communication between the coolant inlet or inlets 314 and the coolant outlet or outlets 316.

Exemplary application of the EV battery pack 300 may be as was heretofore described with respect to the EV battery pack 100 in FIG. 1. Accordingly, the thermal medium passages 312 convey thermal medium 328 from the thermal medium inlet vents 308 to the thermal medium outlet vents 310. The coolant passage or passages 318 convey coolant 330 from the coolant inlet or inlets 314 to the coolant outlet or outlets 316.

Although the embodiments of this disclosure have been described with respect to certain exemplary embodiments, it is to be understood that the specific embodiments are for purposes of illustration and not limitation, as other variations will occur to those of skill in the art.

What is claimed is:

1. A battery pack for an electrified vehicle, comprising:
a battery pack frame;
a plurality of tubular venting components in the battery pack frame; and
at least one of the battery pack frame and the plurality of tubular venting components fabricated at least in part of a tubular material.

2. The battery pack of claim 1 wherein the plurality of tubular venting components includes at least one thermal medium inlet vent, at least one thermal medium outlet vent and at least one thermal medium passage communicating with and extending between the at least one thermal medium inlet vent and the at least one thermal medium outlet vent.

3. The battery pack of claim 2 wherein each of the at least one thermal medium inlet vent, the at least one thermal medium outlet vent and the at least one thermal medium passage is fabricated at least in part of the tubular material.

4. The battery pack of claim 3 wherein each of the at least one thermal medium inlet vent, the at least one thermal medium outlet vent and the at least one thermal medium passage is fabricated in whole of the tubular member.

5. The battery pack of claim 1 wherein the tubular material comprises tubular steel.

6. The battery pack of claim 1 wherein the tubular material comprises tubular aluminum.

7. The battery pack of claim 1 wherein the battery pack frame is fabricated at least in part of the tubular material.

8. The battery pack of claim 7 wherein the battery pack frame is fabricated in whole of the tubular material.

9. A battery pack for an electrified vehicle, comprising:
a battery pack frame;
a plurality of tubular venting components carried by the battery pack frame;
a plurality of cooling components carried by the battery pack frame; and
at least one of the battery pack frame, the plurality of tubular venting components and the plurality of cooling components fabricated at least in part of a tubular material.

10. The battery pack of claim 9 wherein the plurality of tubular venting components includes at least one thermal medium inlet vent, at least one thermal medium outlet vent and at least one thermal medium passage communicating with and extending between the at least one thermal medium inlet vent and the at least one thermal medium outlet vent.

11. The battery pack of claim 10 wherein each of the at least one thermal medium inlet vent, the at least one thermal medium outlet vent and the at least one thermal medium passage is fabricated at least in part of the tubular material.

12. The battery pack of claim 11 wherein each of the at least one thermal medium inlet vent, the at least one thermal medium outlet vent and the at least one thermal medium passage is fabricated in whole of the tubular member.

13. The battery pack of claim 9 wherein the tubular material comprises tubular steel.

14. The battery pack of claim 9 wherein the tubular material comprises tubular aluminum.

15. The battery pack of claim 9 wherein the battery pack frame is fabricated at least in part of the tubular material.

16. The battery pack of claim 9 wherein the battery pack frame is fabricated in whole of the tubular material.

17. An enhanced electrified vehicle battery pack fabrication method, comprising:
fabricating an electrified vehicle battery pack including a battery pack frame and tubular venting and cooling components, at least one of the battery pack frame and the tubular venting and cooling components fabricated at least in part of a tubular material.

18. The method of claim 17 wherein fabricating an electrified vehicle battery pack comprises fabricating an electrified vehicle battery pack including a battery pack frame and tubular venting and cooling components fabricated in whole of a tubular material.

19. The method of claim 17 wherein fabricating an electrified vehicle battery pack comprises fabricating an electrified vehicle battery pack including a battery pack frame and tubular venting and cooling components each fabricated at least in part of tubular aluminum.

20. The method of claim 17 wherein fabricating an electrified vehicle battery pack comprises fabricating an electrified vehicle battery pack including a battery pack frame and tubular venting and cooling components each fabricated at least in part of tubular steel.
